(19) United States
(12) Patent Application Publication
(10) Pub. No.: US 2005/0145078 A1
(43) Pub. Date: Jul. 7, 2005

(54) Quick-release socket adapter for a socket wrench

(76) Inventor: Lee Chang Chuan, Nan Tou Hsien (TW)

Correspondence Address: CHARLES E. BAXLEY, ESQ., 90 JOHN STREET, THIRD FLOOR, NEW YORK, NY, 10038, US

(21) Appl. No.: 10/751,226

(22) Filed: Jan. 2, 2004

(51) Int. Cl. B25G 1/00

(52) U.S. Cl. 81/177.85

(57) ABSTRACT

A quick-release socket adapter for a socket wrench generally comprises: a working head interiorly provided with a space; a handle has an end received in the space of the working head, in the space is further provided with a control rod equipped with a steel ball, a first spring biased between the control rod and the working head; a second spring biased between the handle and the working head. The quick-release adapter for socket wrench in accordance with the present invention is able to enables the loaded socket to be quickly released.

### BACKGROUND OF THE INVENTION

1. Field of the Invention

The present invention relates to a quick-release socket adapter for a socket wrench, and more particularly to a quick-release socket adapter comprising a working head, a handle, a control rod, a steel ball and springs, which is able to enables the loaded socket to be quickly released.

2. Description of the Prior Arts

Most of the conventional quick-release socket wrenches, whatever the structures are, they should be provided in the front of the handle 10 with a working head 12 equipped with control button 11 (as shown in FIG. 1), such kind of conventional quick-release socket structure has been commonly sold and used for a long time, however, there are still some disadvantages need to be improved as follows:

To replace the socket 13 loaded on the working head 12 of the conventional quick-release socket adapter, the user has to hold the handle 10 with one hand while pressing the control button 11 with a finger of the same hand, and meanwhile taking the socket 13 away with another hand. This operation is complicated and it slowdowns the speed of the socket replacement.

The present invention has arisen to mitigate and/or obviate the afore-described disadvantages of the conventional quick-release socket adapter for a socket wrench.

### SUMMARY OF THE INVENTION

The primary object of the present invention is to provide a quick-release socket adapter for a socket wrench, in which, a first end of a handle of the wrench is received in a space of a working head, in the space is provided with a control rod equipped with a steel ball, a first spring biased between the control rod and the working head; a second spring biased between the handle and the working head. The quick-release adapter for socket wrench in accordance with the present invention is able to enables the loaded socket to be quickly released.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a conventional quick-release socket adapter for a socket wrench;

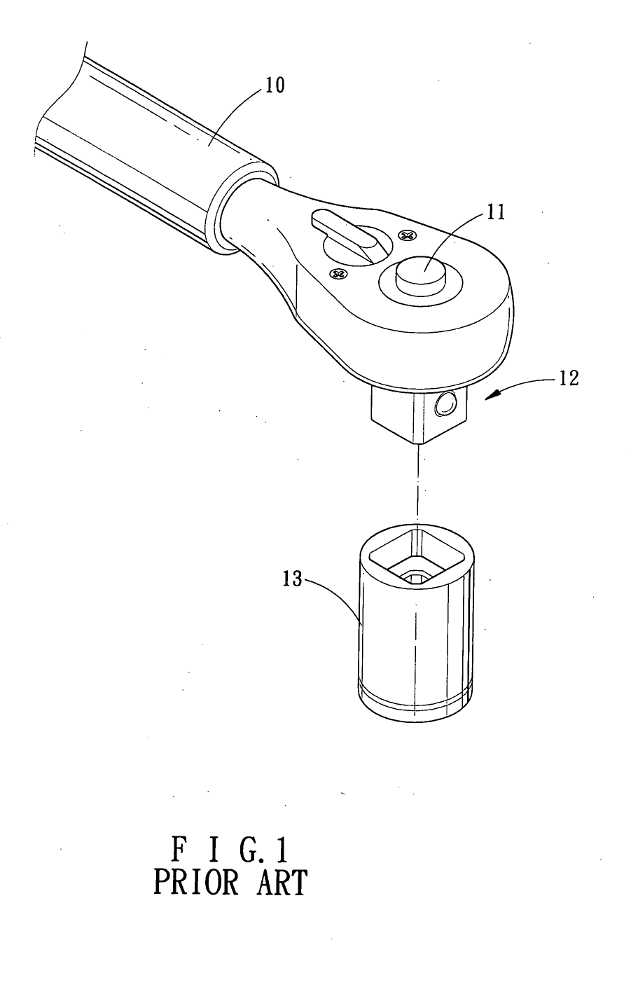

FIG. 2 is a cross sectional view of a quick-release socket adapter for a socket wrench in accordance with the present invention;

FIG. 3 is another cross sectional view of the quick-release socket adapter for a socket wrench in accordance with the present invention;

FIG. 4 is an exploded view of the quick-release socket adapter for a socket wrench in accordance with the present invention.

### DETAILED DESCRIPTION OF THE PREFERRED EMBODIMENT

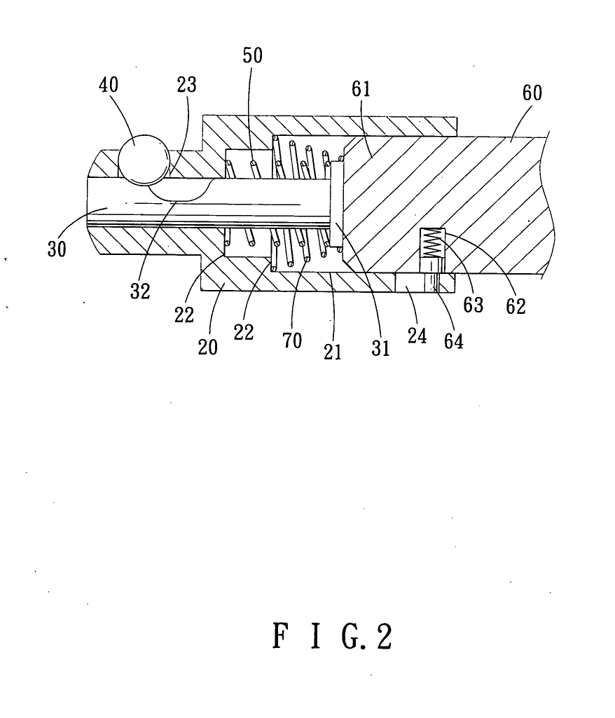

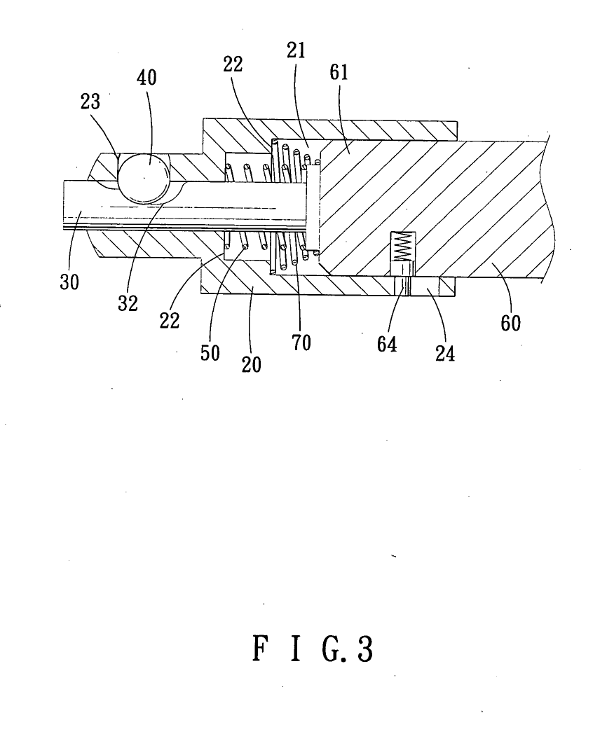

Referring first to FIGS. 2-3, a quick-release socket adapter for a wrench generally comprises a working head 20, a control rod 30, a steel ball 40, a first spring 50, a handle 60 and a second spring 70.

The working head 20 is a tubular member interiorly provided with a space 21, the space 21 is a step hole formed with a shoulder 22. The working head 20 is further provided with a through tapering hole 23 at a side of a first end and a slot 24 at a side of a second end thereof, the tapering hole 23 is transversely pierced outward from the space 21, and the bigger end of tapering hole 23 is located in the internal surface of the space 21.

The control rod 30 is inserted in the space 21 of the working head 20 in a manner that a first end extends out of the space 21 and a second end 31 is confined in the shoulder 22 of the space 21 of the working head 20, furthermore, the control rod is defined with a curved peripheral notch 32 which corresponds to the tapering hole 23 of the working head 20.

The steel ball 40 is confined in the tapering hole 23 of the working head 20 and retained by the control rod 30, which can roll between the control rod 30 and the curved peripheral notch 32.

The first spring 50 is biased between the second end 31 of the control rod 30 and the shoulder 22 of the space 21 of the working head 20.

The handle 60 is a rod member having an inserting end 61 correspondingly inserted in the space 21 of the working head 20, contiguous to the inserting end 61 a hole 62 is defined in corresponding to the slot 24 in the internal surface of the space 21 of the working head 20. In the hole 62 a spring 63 and a stepped pin 64 are received respectively in turn, the stepped pin 64 is pushed partially in the slot 24 of the working head 20 by virtue of the spring 63, such that the inserting end 61 of the handle 60 is confined in the space 21 of the working head 20.

The second spring 70 is biased between the inserting end 61 of the handle 60 and the shoulder 22 of the space 21 of the working head 20.

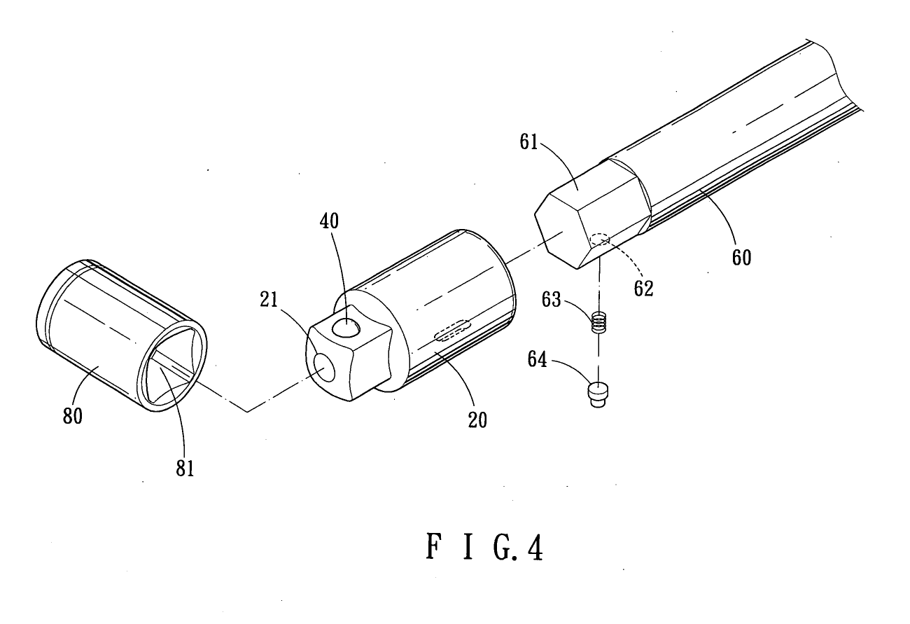

Referring now to FIG. 4, in which, to engage with a socket 80, the user should initially hold the handle 60 with one hand and hole the socket 80 with another hand, and then push the handle 60 a little forward (towards the socket 80) so as to compress the second spring 70 with the inserting end 61 of the handle 60 and simultaneously push the end 31 of the control rod 30. Thus the first spring 50 is compressed and begins to restore elastic force. Meanwhile, the control rod 30 slides in the space 21 of the working head 20, and thus the curved peripheral notch 32 corresponding to the tapering hole 23 of the working head 20 slides too, so that the steel ball 40 rolls from the control rod 30 into the curved peripheral notch 32.

The steel ball 40 will not protrude out of the tapering hole 23 of the working head 20 after it fell into the curved peripheral notch 32, thereby the user is able to insert the working head 20 into the socket 80 without difficulty.

And then the user stops pushing, the second spring 70 and the first spring 50 start to release the elastic force so as to push the inserting end 61 of the handle 60 and the control rod 30 back to original position simultaneously, whereas the steel ball 40 rolls again onto the control rod 30 from the curved peripheral notch 32 and protrudes partially out of the tapering hole 23 of the working head 20. And in the meantime, the steel ball 40 will engage in a groove 81 inside of the socket 80. In this way, the socket 80 is secured to the working head 20. In addition, to disassemble the socket 80, the user should apply forces on the handle 60 with a hand in the same way as he did when assembling the socket 80. Thus, the assembly or disassembly of the socket 80 in accordance with the present invention is very simple and easy, which conforms to the ergonomics.

It will be noted that the inserting end 61 of the handle 60 is engaged with the working head 20 by virtue of the stepped pin 64. The stepped pin 64 together with the spring 63 are received in the slot 24 so as to allow the inserting end 61 of the handle 60 to reciprocate in a range of the slot 24 without disengaging from the space 21 of the working head 20.

While we have shown and described various embodiments in accordance with the present invention, it should be clear to those skilled in the art that further embodiments may be made without departing from the scope of the present invention.

1. A quick-release socket adapter for a socket wrench comprising:
a working head being a tubular member interiorly provided with a space, the space being a step hole, the working head further provided with a through tapering hole at a first end and a slot at a second end thereof, a bigger end of the tapering hole being located in an internal surface of the space;
a control rod inserted in the space of the working head in a manner that a first end extending out of the space and a second end confined in the space of the working head, the control rod being defined with a curved peripheral notch in corresponding to the tapering hole of the working head;
a steel ball confined in the tapering hole of the working head and retained by the control rod;
a first spring biased between the second end of the control rod and the shoulder of the working head;
a handle being a rod member having an inserting end correspondingly inserted in the space of the working head, contiguous to the inserting end a hole being defined in corresponding to the slot in the internal surface of the space of the working head, in the hole a spring and a pin being received respectively in turn, the pin being pushed partially in the slot of the working head by virtue of the spring, whereby to confine the inserting end of the handle in the space of the working head;
a second spring biased between the inserting end of the handle and the shoulder of the working head.

2. The quick-release socket adapter for a socket wrench as claimed in claim 1, wherein the pin of the handle can be step shaped, such that the pin is easy to be received in the slot.
